(19) United States
(12) Patent Application Publication
(10) Pub. No.: US 2010/0194793 A1
(43) Pub. Date: Aug. 5, 2010

(54) CHOLESTERIC LIQUID CRYSTAL DISPLAY DEVICE

(75) Inventor: Hirokata Uehara, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/681,656

(22) Filed: Apr. 5, 2010

Related U.S. Application Data
(63) Continuation of application No. PCT/JP2007/070101, filed on Oct. 15, 2007.

(51) Int. Cl. G09G 5/10; G06F 3/038

(52) U.S. Cl. 345/691; 345/212; 345/89

(57) ABSTRACT

A display device includes: a display element of a dot matrix type; a row driver that drives a row electrode of the display element; a column driver that drives a column electrode of the display element; and a multiple voltage power source that supplies a drive voltage to the row driver and the column driver, wherein: the row driver and the column driver are configured by a segment driver; and the device includes a power source switching switch which switches drive voltages to be supplied to the row driver in accordance with the polarity of an applied voltage to be applied to a pixel of the display element.

### CROSS-REFERENCE TO RELATED APPLICATIONS

This application is a continuation application and is based upon PCT/JP2007/070101, filed on Oct. 15, 2007, the entire contents of which are incorporated herein by reference.

### FIELD

The embodiment discussed herein is related to a display device including a display element of a dot matrix type having a display material with memory properties, such as a cholesteric liquid crystal and a drive method thereof.

### BACKGROUND

In recent years, the development of electronic paper has been promoted in companies, universities, etc. Applied fields expected to utilize electronic paper have been proposed, including a variety of fields, such as electronic books, a sub-display for mobile terminal equipment, and a display part of an IC card. One promising method of electronic paper is that which uses a cholesteric liquid crystal. A cholesteric liquid crystal has excellent characteristics, such as the ability to semipermanently hold a display (memory property), vivid color display, high contrast, and high resolution.

Cholesteric liquid crystals are also referred to as chiral nematic liquid crystals, which form a cholesteric phase in which molecules of the nematic liquid crystal are in the form of a helix by adding a comparatively large amount (a few tens of percent) of additives (chiral material) having chiral property to the nematic liquid crystal.

FIG. 1A and FIG. 1B are diagrams explaining the states of the cholesteric liquid crystals. As illustrated in FIG. 1A and FIG. 1B, a display element 10 that utilizes cholesteric liquid crystals has an upper side substrate 11, a cholesteric liquid crystal layer 12, and a lower side substrate 13. Cholesteric liquid crystals have a planar state in which incident light is reflected as illustrated in FIG. 1A and a focal conic state in which incident light is transmitted as illustrated in FIG. 1B, and theses states are maintained stably even if there is no electric field.

In the planar state, light having a wavelength in accordance with the helical pitch of liquid crystal molecules is reflected. A wavelength λ at which reflection is maximum is expressed by the following expression where n is an average refractive index and p is a helical pitch

λ=n·p.

On the other hand, a reflection band Δλ differs considerably depending on a refractive index anisotropy Δn of liquid crystal.

In the planar state, a “bright” state, i.e., white can be displayed because incident light is reflected. On the other hand, in the focal conic state, a “dark” state, i.e., black can be displayed because light having passed through the liquid crystal layer is absorbed by a light absorbing layer provided under the lower side substrate 13.

Next, a method of driving a display element that utilizes cholesteric liquid crystals is explained.

FIG. 2 illustrates an example of a voltage-reflection characteristic of general cholesteric liquid crystals. The horizontal axis represents a voltage value (V) of a pulse voltage to be applied with a predetermined pulse width between electrodes that sandwich cholesteric liquid crystals and the vertical axis represents a reflectivity (%) of cholesteric liquid crystals. A curve P of a solid line illustrated in FIG. 2 represents the voltage-reflectivity characteristic of cholesteric liquid crystals when the initial state is the planar state and a curve FC of a broken line represents the voltage-reflectivity characteristic of cholesteric liquid crystals when the initial state is the focal conic state.

In FIG. 2, if a predetermined high voltage VP100 (for example, ±36 V) is applied between the electrodes to generate a relatively strong electric field in the cholesteric liquid crystal, the helical structure of the liquid crystal molecules is undone completely and a homeotropic state is brought about, where all of the molecules align in the direction of the electric field. Next, when the liquid crystal molecules are in the homeotropic state, if the applied voltage is reduced rapidly from VP100 to a predetermined low voltage (for example, VF0=±4 V) to reduce the electric field in the liquid crystal almost to zero, the helical axis of the liquid crystal becomes perpendicular to the electrode and the planar state is brought about, where light in accordance with the helical pitch is reflected selectively.

On the other hand, if a predetermined low voltage VF100b (for example, ±24 V) is applied between electrodes to generate a relatively weak electrical field in the cholesteric liquid crystal, a state is brought about where the helical structure of the liquid crystal molecules is not undone completely. In this state, if the applied voltage is reduced rapidly from VF100b to the low voltage VF0 to rapidly reduce the electric field in the liquid crystal almost to zero, or to gradually remove the electric field by applying a strong electric field, the helical axis of the liquid molecule becomes parallel with the electrode and the focal conic state where incident light is transmitted is brought about.

Further, if the electric field is removed rapidly by applying an electric field of intermediate strength, the planar state and the focal conic state coexist in a mixed condition and it is possible to display a halftone.

A display is produced by utilizing the above-mentioned phenomena.

The principles of a driving method based on the voltage response characteristic described above are explained with reference to FIG. 3A to FIG. 3C.

FIG. 3A illustrates the pulse response characteristic when the pulse width of a voltage pulse is a few tens of ms, FIG. 3B illustrates the pulse response characteristic when the pulse width of a voltage pulse is 1.88 ms, and FIG. 3C illustrates the pulse response characteristic when the pulse width of a voltage pulse is 0.94 ms. In each figure, a voltage pulse to be applied to a cholesteric liquid crystal is illustrated on the upper side and the voltage-reflectivity characteristic is illustrated on the lower side, and the horizontal axis represents a voltage (V) and the vertical axis represents reflectivity (%). As a well known drive pulse of a liquid crystal, a voltage pulse is a combination of a positive polarity pulse and a negative polarity pulse in order to prevent the liquid crystal from deteriorating due to polarization.

As illustrated in FIG. 3A, when the pulse width is great, as illustrated by the solid line, if the initial state is the planar state, the state changes into the focal conic state when the voltage is raised to a certain range and if the voltage is further raised, the state changes into the planar state again. As illustrated by the broken line, when the initial state is the focal conic state, the state gradually changes into the planar state as the pulse voltage is raised.

When the pulse width is great, the voltage pulse, at which the state changes into the planar state whether the initial state is the planar state or the focal conic state, is ±36 V in FIG. 3A. With a pulse voltage in the middle of this range, the state is such that the planar state and the focal conic state coexist in a mixed condition, and therefore, a halftone can be obtained.

On the other hand, when the pulse width is 2 ms as illustrated in FIG. 3B, when the initial state is the planar state, the reflectivity remains unchanged when the voltage pulse is about 10 V, however, at higher voltages, the state is such that the planar state and the focal conic state coexist in a mixed condition, and therefore, the reflectivity is reduced. The amount of reduction in reflectivity increases as the voltage is increased; however, when the voltage is increased than 36 V, the amount of reduction in reflectivity becomes constant. This is also the same when the initial state is a state where the planar state and the focal conic state coexist in a mixed condition. Because of this, when the initial state is the planar state, if a voltage pulse having a pulse width of 2 ms and a pulse voltage of about 20 V is applied once, the reflectivity is reduced by a certain amount. In this manner, in the state where the planar state and the focal conic state coexist in a mixed condition and the reflectivity is reduced by a small amount, if a voltage pulse having a pulse width of 2 ms and a pulse voltage of about 20 V is further applied, the reflectivity is reduced further. If this is repeated, the reflectivity is reduced to a predetermined value.

As illustrated in FIG. 3C, when the pulse width is 1 ms, the reflectivity is reduced when a voltage pulse is applied in a manner similar to that when the pulse width is 2 ms; however, the amount of reduction in reflectivity is smaller compared to the case where the pulse width is 2 ms.

From the above, it can be thought that if a pulse of 36 V having a pulse width of several ten milliseconds is applied, the state planar state is brought about and if a gradation pulse of about ten-something to 20 V is applied, a state where the planar state and the focal conic state coexist in a mixed condition is brought about and the reflectivity is reduced, and the amount of reduction in reflectivity depends on the cumulative time of the gradation pulse.

As to the multi-gradation display method by cholesteric liquid crystal, there have been proposed various driving methods. The method of driving a multi-gradation display by cholesteric liquid crystal is divided into a dynamic driving method and a convention driving method.

Japanese Laid-open Patent Publication No. 2001-228459 describes a dynamic driving method. However, the dynamic driving method uses complicated drive waveforms, and therefore, requires a complicated control circuit and a driver IC and also requires a transparent electrode of the panel, having a low resistance, resulting in a problem that the manufacturing cost is increased. Further, the dynamic driving method has a problem that power consumption is large.

Y.-M. Zhu, D-K. Yang, Cumulative Drive Schemes for Bistable Reflective Cholesteric LCDs, SID 98 DIGEST, pp 798-801, 1998 describes the conventional driving method. This Non-patent document describes a method of driving the state gradually from a planar state to a focal conic state, or from the focal conic state to the planar state at a comparatively high semi-moving picture rate by making use of the cumulative time inherent in liquid crystal and adjusting the number of times of application of a short pulse.

However, in the driving method described in this non-patent document, because of such a high semi-moving picture rate, the drive voltage is as high as 50 to 70 V, and this is a factor that increases the cost. Further, the “two phase cumulative drive scheme” described in this non-patent document uses the cumulative times in two directions, i.e., the cumulative time to the planar state and the cumulative time to the focal conic state using the two stages, i.e., the “preparation phase” and the “selection phase”, and therefore, there is a problem of display quality. Further, a fine pulse is applied a number of times, and therefore, the driving method described in this non-patent document has a problem that power consumption is large.

Japanese Laid-open Patent Publication No. 2000-147466 and Japanese Laid-open Patent Publication No. 2000-171837 describe a method of driving a fast-forward mode that applies resetting to the focal conic state. This driving method has an advantage that a comparatively high contrast can be obtained compared to the above-mentioned driving method, however, the writing after resetting requires a high voltage that is difficult to achieve by a general-purpose STN driver, and further, the writing is cumulative one toward the planar state, and therefore, the crosstalk to the half-selected or non-selected pixel becomes a problem. In addition, this driving method also has a problem that power consumption is large because a fine pulse is applied a number of times.

When a gradation is set by making use of the cumulative time using the conventional driving method, there can be conceived of a method of varying the pulse width, in addition to the method of adjusting the number of times of application of a short pulse as described above. The method of varying the pulse width is more advantageous than the method of adjusting the number of times of application of a short pulse from the standpoint of suppression of power consumption. Hereinafter, the method of setting a gradation by varying the pulse width to change the cumulative time is referred to as a PWM (Pulse Width Modulation) method.

Japanese Laid-open Patent Publication No. 04-62516 describes a configuration in which a positive polarity pulse and a negative polarity pulse having different pulse widths are applied in a liquid crystal display device, although the display device does not use cholesteric liquid crystal. FIG. 4A to FIG. 4C illustrate examples of pulses of different pulse widths described in cited document 4, wherein the pulse width is longer in order of FIG. 4A, FIG. 4B and FIG. 4C. The pulses illustrated in FIG. 4A to FIG. 4C have the same length of one unit pulse and have a positive polarity pulse and a negative polarity pulse of different pulse widths. By making use of such a pulse, it is possible to prevent deterioration due to the polarization of the liquid crystal.

As described above, the methods of varying a gradation by varying the cumulative time include the method of varying the number of times of application of a short pulse and the method of varying the pulse width (PWM method), and in either method, voltages as illustrated in FIG. 5 are applied to a pixel. The cholesteric liquid crystal changes its state when a large voltage is applied whether the voltage is positive or negative. In a liquid crystal display device that uses cholesteric liquid crystal, scan lines extending in the transverse direction are written one by one and an action to shift the scan line to be written is repeated. In order to do so, the selected scan line is set to the ground level and a voltage of intermediate magnitude (for example, 15 V) is applied to other non-selected scan lines. To a data line that extends in the longitudinal direction, a pulse having a large voltage (20 V) is applied; however, if the voltage of the part other than the pulse width is set to the ground level, a large voltage having the opposite polarity (−15 V) is applied to the pixel in the non-selected line, and therefore, the state of the liquid crystal changes. In order to prevent such a change, in a liquid crystal display device that uses cholesteric liquid crystal, a pulse having a base voltage of +10 V and a pulse voltage of +20 V is used in the positive polarity phase and a pulse having a base voltage of −10 V and a pulse voltage of −20 V is used in the negative polarity phase. Because of this, +5 V or −5 V is applied to the pixel of the non-selected scan line and the state of the liquid crystal does not change its state. In the selected scan line, +20 V or −20V is applied to the pulse part and +10 V or −10 V is applied to other base parts.

FIG. 6 is a diagram illustrating a configuration of the whole display device in the conventional example that uses a display element 10 of dot matrix type having a display material with memory properties, such as cholesteric liquid crystal. For example, the display element 10 is in conformity with the A4 size/XGA specifications and has 1,024×768 pixels. A power source 21 outputs a voltage of, for example, 3 V to 5V. A step-up part 22 steps up an input voltage from the power source 21 to 36 V to 40 V by a regulator, such as a DC-DC converter. A multiple voltage generation part 23 generates a plurality of voltages to be supplied to a row driver (common driver) 26 and a column driver (segment driver) 27 from the stepped-up voltage. A clock source 24 outputs clocks used to control each part. A driver control circuit 25 outputs several control signals and controls the row driver 26 and the column driver 27. Scan line data SLD is data that the row driver 26 lathes and shifts sequentially. A data take-in clock XCLK is a clock with which the column driver 27 internally transfers image data. A frame start signal DIO is a signal that specifies the update of a display line. A pulse polarity control signal FR is a polarity inverted signal of an applied voltage. A scan shift signal LP_COM is a signal that specifies the update of a display line in the row driver 26. /DSPOF is a forced OFF signal of an applied voltage. A column data latch signal LP_SEG is a signal that specifies the update of a display line in the column driver 27. To the column driver 27, image data is input.

The row driver (common driver) 26 drives the 768 scan lines and the column driver (segment driver) 27 drives the 1,024 data lines. Because image data given to each pixel of RGB are different, the column driver 27 drives each data line independently. The row driver 26 drives the lines of RGB commonly. As the row driver (common driver) 26 and the column driver (segment driver) 27, a general-purpose STN driver that output two values is used, respectively. Widely-used drive ICs include a common driver IC and a segment driver IC and in addition, there is an IC that can be used as a common driver and a segment driver in accordance with a voltage to be applied to a mode switching terminal.

FIG. 7 is a time chart illustrating a drive sequence of the gradation write operation in the conventional display device in FIG. 6. When the display line is updated by applying LP_COM and LP_SEG, the column driver 27 is supplied with data corresponding to one line in accordance with XCLK, and when the data of 1,024 pixels is shifted and pixel data corresponding to one line is prepared, if LP_COM and LP_SEG are applied, the row driver 26 outputs a pulse in the positive polarity phase to one scan line and the column driver 27 outputs a pulse in the positive polarity phase in accordance with the image corresponding to one line to the 1,024 data lines. When the application of the pulse in the positive polarity phase is completed, a pulse in the negative polarity phase is applied. In parallel with this, pixel data corresponding to the next one line is supplied in the same manner described above. After that, the same processing is repeated and pulses in the positive polarity and negative polarity phases in accordance with the display data are applied to the entire screen. When the cumulative application time of a pulse in accordance with a gradation level is adjusted by the number of pulses, the number of times of application of a pulse is varied for each data line and when the cumulative application time is adjusted by the pulse length, the width of a pulse to be applied is varied for each data line.

In the reset processing to bring all of the pixels into the planar state, symmetric pulses of a high voltage (for example, 36 V) having a great pulse width in the positive polarity and negative polarity phases are applied to all of the pixels.

The driving method illustrated in FIG. 7 is widely known, and therefore, further explanation is omitted here.

FIG. 8A to FIG. 8C are each a diagram illustrating a drive example where the display device in FIG. 6 is actuated by the drive sequence in FIG. 7. In the example in FIG. 8A, the row driver 26 applies a scan pulse to the first line that is selected and the column driver 27 outputs an ON/OFF voltage in accordance with the image data of the first line. In the example in FIG. 8B, the row driver 26 applies a scan pulse to the second line that is selected and the column driver 27 outputs an ON/OFF voltage in accordance with the image data of the second line. In the example in FIG. 8C, the row driver 26 applies a scan pulse to the third line that is selected and the column driver 27 outputs an ON/OFF voltage in accordance with the image data of the third line. The image data of the third line represents a display in which all the pixels are black, i.e., a back line in the transverse direction.

FIG. 9A illustrates a configuration of a general-purpose segment driver and FIG. 9B illustrates a configuration of a general-purpose common driver. As illustrated in FIG. 9A, the segment driver has a data register 31, a latch register 32, a voltage conversion part 33 that converts a logic voltage into an LCD drive voltage, and an output driver 34. The latch register 32 takes in data corresponding to one line from the data register 31 in accordance with the data latch signal LP_SEG. The voltage conversion part 33 outputs an LCD drive voltage corresponding to one line in accordance with the data that is taken into the latch register 32 from the output driver 34 at the same time. The segment driver has two buffers for two lines for the data register 31 and the latch register 32, and therefore, can store data for the next line in the data register 31 while the data of the latch register 32 is being output.

As illustrated in FIG. 9B, the common driver has a shift register 41, a latch register 42, a voltage conversion part 43, and an output driver 44. The shift register 41 shifts data representing a scan line to be selected in accordance with the scan shift signal LP_COM. Due to this, the screen is scanned by one line each. The common driver is used for scanning, and therefore, does not have a function of receiving data for the next line and storing the data while a voltage is being output, which the segment driver has.

FIG. 10A illustrates an output voltage of a general-purpose segment driver and FIG. 10B illustrates an output voltage of a general-purpose common driver. As illustrated in FIG. 10A, the general-purpose segment driver outputs V0 when the data signal is “1” and the polarity control signal FR is “1”, outputs the ground level (GND) when the polarity control signal FR is “0”, V21 when the data signal is “0” and the polarity control signal FR is “1, and V34 when the polarity control signal FR is “0”. V0, V21 and V34 are voltages supplied to the general-purpose segment driver from outside and they need to satisfy the restrictive conditions that V0≧V21≧V34≧GND.

As illustrated in FIG. 10B, the general-purpose common driver outputs GND when the data signal is “1” and the polarity control signal FR is “1”, outputs V0 when the polarity control signal FR is “0”, V21 when the data signal is “0” and the polarity control signal FR is “1”, and outputs V34 when the polarity control signal FR is “0”. V0, V21 and V34 are voltages supplied to the general-purpose common driver from outside and they need to satisfy the restrictive conditions that V0≧V21≧V34≧GND. Here, V21 and V34 output from the segment driver are denoted as V21S and V34S, and V21 and V34 output from the common driver as V21C and V34C.

In a display device that uses the cholesteric liquid crystal, a column driver (segment driver) and a row driver (common driver) output, for example, a pulse as illustrated in FIG. 11A as a gradation pulse to be applied to change from the planar state into a halftone level. By applying such a pulse, pulses as illustrated in FIG. 11B are applied to a pixel.

To the column driver, 20 V is supplied as V0, and 10 V as V21S and V34C, and as illustrated in FIG. 11A, in the positive polarity phase (FR=1), a positive pulse is output and in the negative polarity phase (FR=0), a negative pulse is output.

To the row driver, 20 V is supplied as V0, 15 V as V21C, and 5 V as V34S, and as illustrated in FIG. 11A, in the positive polarity phase (FR=1), a negative pulse is output and in the negative polarity phase (FR=0), a positive pulse is output.

Because such a pulse illustrated in FIG. 11A is applied, when the scan line is in the selected state (the common driver is ON) and the data line is also in the selected state (the segment driver is ON), 20 V is applied in the positive polarity phase (FR=1) and −20 V is applied in the negative polarity phase (FR=0). When the scan line is in the selected state (the common driver is ON) and the data line is in the non-selected state (the segment driver is OFF), 10 V is applied in the positive polarity phase (FR=1) and −10 V is applied in the negative polarity phase (FR=0). When the scan line is in the non-selected state (the common driver is OFF) and the data line is in the selected state (the segment driver is ON), 5 V is applied in the positive polarity phase (FR=1) and −5 V is applied in the negative polarity phase (FR=0). When the scan line is in the non-selected state (the common driver is OFF) and the data line is in the non-selected state (the segment driver is OFF), −5 V is applied in the positive polarity phase (FR=1) and 5 V is applied in the negative polarity phase (FR=0).

FIG. 12 is a diagram illustrating part of a configuration of the multiple voltage generation part 23. Four voltage levels are generated by dividing the reference voltage using resistors and they are amplified and thus V0 (20 V), V21C (15 V), V21S and V34S (10 V), and V34C (5 V) are generated. In addition, a voltage of 36 V used in reset processing is generated to bring about the planar state; however, it is not illustrated schematically here.

The display device that uses cholesteric liquid crystal is explained as above as a display device in a conventional example, however, an embodiment is not limited to the above and can be applied to any display device as long as it has memory properties.

### SUMMARY

According to a first aspect of the embodiment, a display device includes: a display element of dot matrix type; a row driver that drives a row electrode of the display element; a column driver that drives a column electrode of the display element; and a multiple voltage power source that supplies a drive voltage to the row driver and the column driver, wherein: the row driver and the column driver are configured by a segment driver; and the device includes a power source switching switch which switches drive voltages to be supplied to the row driver in accordance with the polarity of an applied voltage to be applied to a pixel of the display element.

According to a second aspect of the embodiment, in a method of driving a display device including: a display element of dot matrix type; a row driver that drives a row electrode of the display element; a column driver that drives a column electrode of the display element; and a multiple voltage power source that supplies a drive voltage to the row driver and the column driver, the row driver and the column driver are configured by a segment driver; and drive voltages to be supplied to the row driver are switched in accordance with the polarity of an applied voltage to be applied to a pixel of the display element.

The object and advantages of the embodiment will be realized and attained by means of the elements and combination particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1A is a diagram explaining a planar state of a cholesteric liquid crystal;

FIG. 1B is a diagram explaining a focal conic state of a cholesteric liquid crystal;

FIG. 2 is a diagram explaining a state change of a cholesteric liquid crystal by a pulse voltage;

FIG. 3A is a diagram explaining a change in reflectivity by a pulse having a large voltage and a great pulse width to be applied to a cholesteric liquid crystal;

FIG. 3B is a diagram explaining a change in reflectivity by a pulse having an intermediate voltage and a narrow pulse width to be applied to a cholesteric liquid crystal;

FIG. 3C is a diagram explaining a change in reflectivity by a pulse having an intermediate voltage and a narrower pulse width to be applied to a cholesteric liquid crystal;

FIG. 4A is a diagram illustrating an example in which the pulse width of a symmetric pulse to be applied to a liquid crystal is narrow;

FIG. 4B is a diagram illustrating an example in which the pulse width of a symmetric pulse to be applied to a liquid crystal is intermediate;

FIG. 4C is a diagram illustrating an example in which the pulse width of a symmetric pulse to be applied to a liquid crystal is great;

FIG. 5 is a diagram illustrating an example of a symmetric pulse to be applied to a cholesteric liquid crystal;

FIG. 6 is a diagram illustrating a general configuration of a conventional display device that uses a cholesteric liquid crystal;

FIG. 7 is a time chart illustrating a drive sequence of a conventional display device;

FIG. 8A is a diagram explaining a drive example in a conventional display device;

FIG. 8B is a diagram explaining a drive example in a conventional display device;

FIG. 8C is a diagram explaining a drive example in a conventional display device;

FIG. 9A is a diagram illustrating a configuration of a general-purpose segment driver;

FIG. 9B is a diagram illustrating a configuration of a general-purpose common driver;

FIG. 10A is a diagram illustrating output voltages of a general-purpose segment driver;

FIG. 10B is a diagram illustrating output voltages of a general-purpose common driver;

FIG. 11A is a diagram illustrating output pulses of a general-purpose segment driver and a general-purpose common driver in a display device;

FIG. 11B is a diagram illustrating applied voltages to a liquid crystal by the output pulses in FIG. 11A;

FIG. 12 is a diagram illustrating a configuration of part of a multiple voltage power source;

FIG. 13A is a diagram explaining an example of the simultaneous drive of a plurality of lines;

FIG. 13B is a diagram explaining an example of the simultaneous drive of a plurality of lines;

FIG. 14 is a diagram illustrating a laminated structure of a cholesteric liquid crystal element of a color display device in an embodiment;

FIG. 15 is a diagram illustrating a structure of one cholesteric liquid crystal element of a color display device in an embodiment;

FIG. 16 is a diagram illustrating a general configuration of a color display device in an embodiment;

FIG. 17 is a diagram illustrating a configuration of part of a multiple voltage power source;

FIG. 18 is a time chart illustrating a drive sequence of a display device in an embodiment;

FIG. 19A is a diagram illustrating applied voltages to a liquid crystal by output pulses of the column driver and the row driver in the positive polarity phase;

FIG. 19B is a diagram illustrating applied voltages to a liquid crystal by output pulses of the column driver and the row driver in the negative polarity phase.

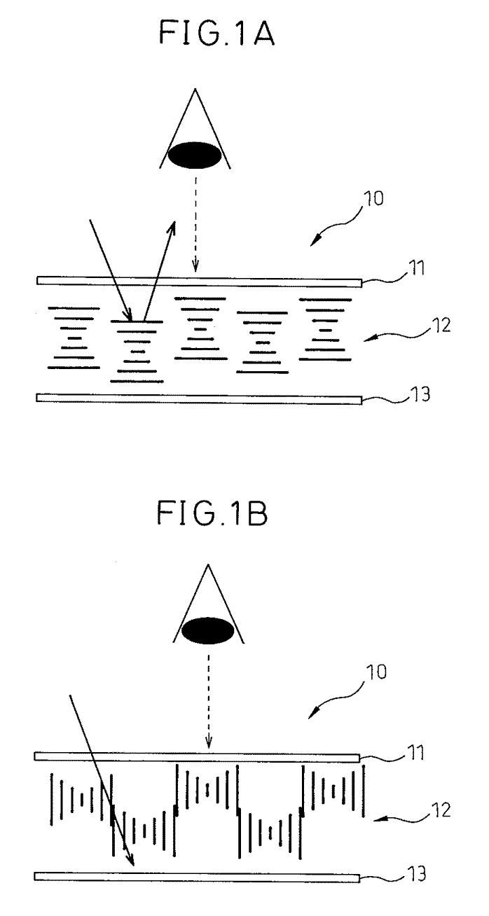

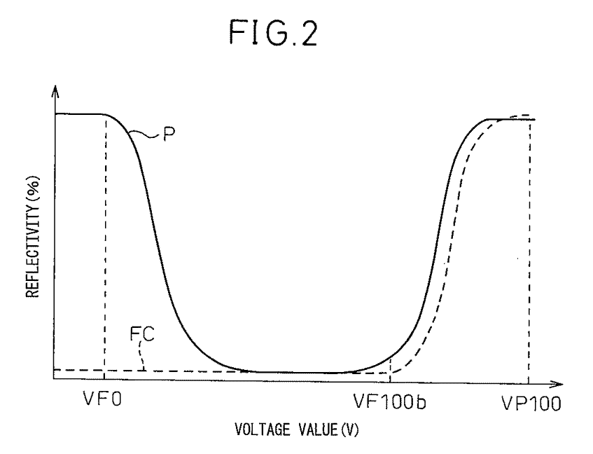

### DESCRIPTION OF EMBODIMENT

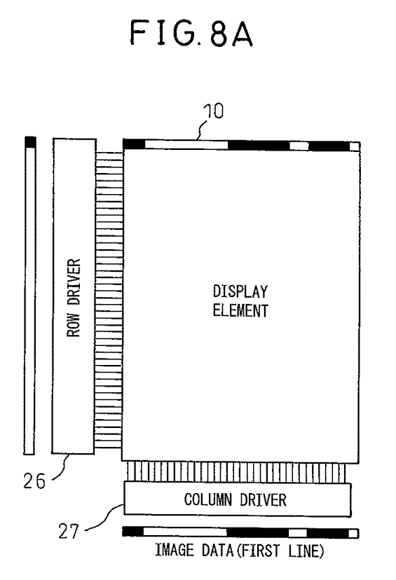

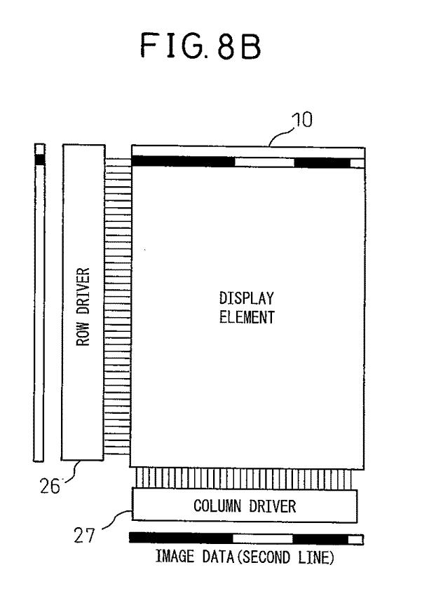

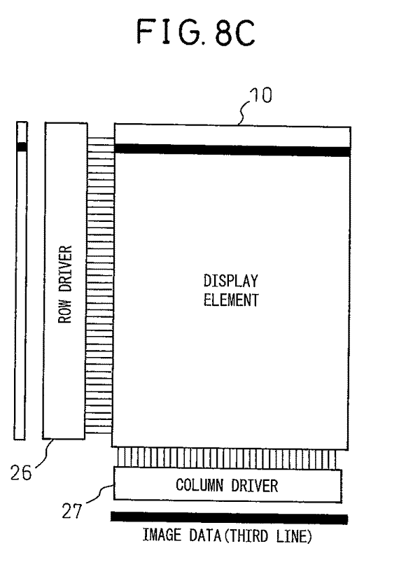

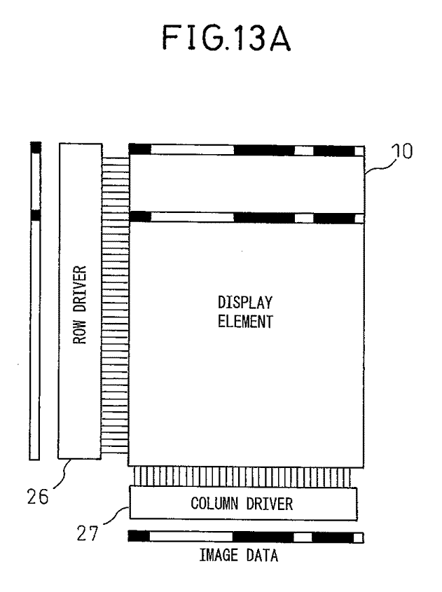

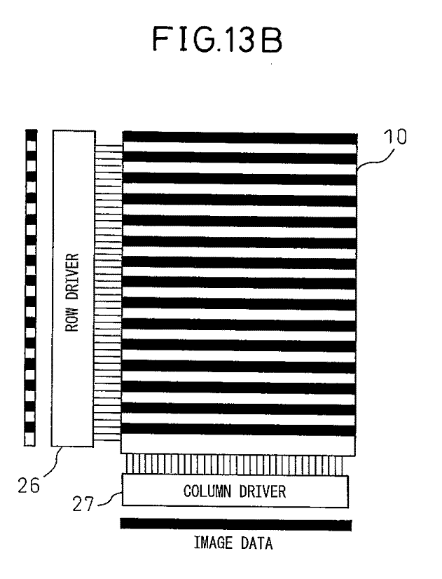

As illustrated in FIG. 8A to FIG. 8C, the conventional display device performs wiring while scanning lines one by one. If lines having the same image data corresponding to one line, such as a horizontal line, a white or black belt-shaped part, are written at the same time, the write speed of the display device can be increased, and therefore, it is demanded to enable such write processing. FIG. 13A and FIG. 13B are diagrams explaining such write processing. FIG. 13A illustrates a case where two lines having the same image data are written at the same time. FIG. 13B illustrates a case where a number of lines constituting a black part of a belt-shaped pattern are written at the same time.

However, the conventional general-purpose common driver is a scan driver, and therefore, it is not possible to select a plurality of lines at high speed. Because of this, if the row driver is configured by a general-purpose common driver, the simultaneous drive of a plurality of lines illustrated in FIG. 13A and FIG. 13B cannot be performed.

If a dedicated driver is used, it is possible to simultaneously drive a plurality of lines; however, such a dedicated driver is very expensive compared to a general-purpose driver, and there arises a problem that the cost of the display device is increased.

According to an embodiment, a display device having a display element of dot matrix type, which has enabled the simultaneous drive of a plurality of lines using an inexpensive general-purpose driver, will be realized.

In a display device of the embodiment, both the row driver and the column driver are configured by a segment driver, a power source switching switch that switches drive voltages to be supplied to the row driver in accordance with the polarity of an applied voltage to be applied to a pixel of a display element is provided in a multiple voltage power source, and a signal obtained by inverting the pulse polarity signal FR to be supplied to the column driver is used as the pulse polarity signal FR to be supplied to the row driver.

The constitution of the embodiment can be applied to any display device that uses a display material with memory properties; however, in particular, it is preferable for the embodiment to be applied to a display device, such as electronic paper that uses a liquid crystal that forms a cholesteric phase.

In a display device using a liquid crystal that forms a cholesteric phase, the initial gradation state is the planar state and a gradation state other than the initial gradation state is a state where the planar state and the focal conic state coexist in a mixed condition and a halftone value is determined by a coexistence ratio. The display element is brought into the initial gradation state by the application of an initialization voltage pulse to the pixel and then brought into a gradation state other than the initial gradation state by the application of a gradation voltage pulse to the initialized pixel, and the cumulative time during which a gradation pulse is applied is related to a value of the gradation state. It is possible for the display element to produce a color display by comprising a laminated structure in which a plurality of display elements that exhibit a plurality of different kinds of reflected light are laminated.

In the embodiment, as the row driver, a general-purpose segment driver is used. Unlike the common driver, the segment driver is capable of outputting various pieces of data, not only shifting data, and therefore, the simultaneous drive of a plurality of lines is possible. The general-purpose segment driver is inexpensive compared to a dedicated driver.

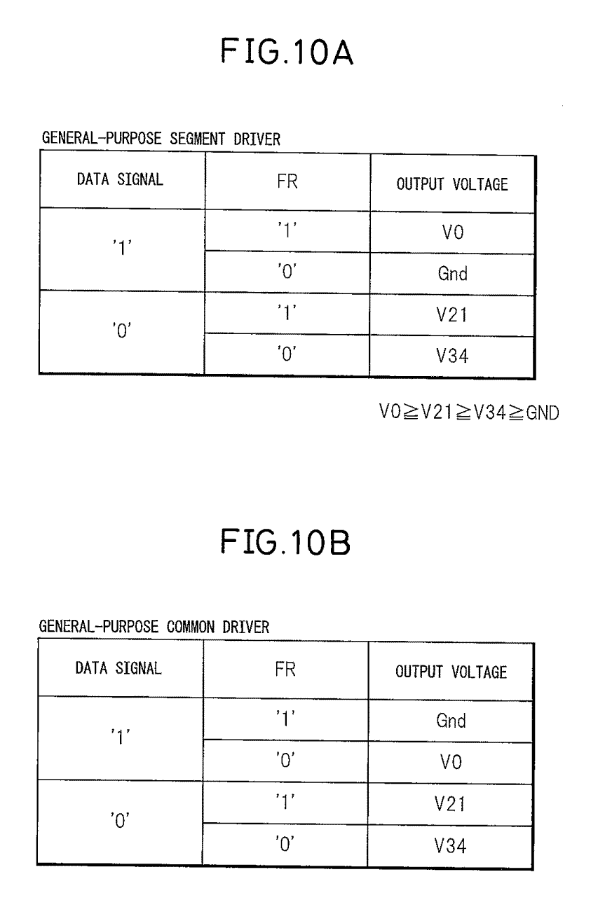

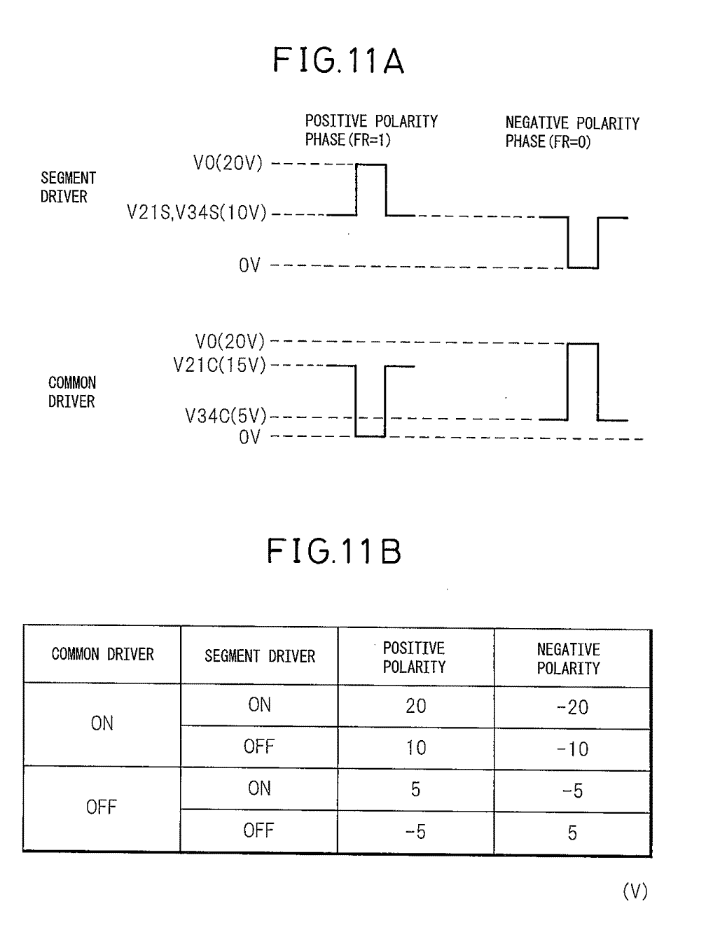

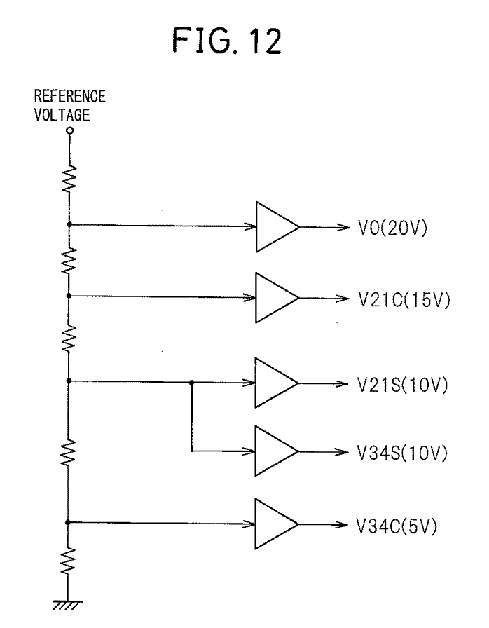

Further, most of the general-purpose segment drivers have line buffers corresponding to a plurality of lines, and therefore, it is possible to receive the next line data during the period of application of a voltage, and therefore, the data transfer efficiency is improved compared to when a common driver is used. Furthermore, the general-purpose segment driver needs to satisfy the voltage restrictive conditions V0≧V21≧V34 illustrated in FIG. 10A; however, this relationship can be satisfied by voltage switching control.

In the following, a detailed constitution of an embodiment is explained below with reference to the drawings.

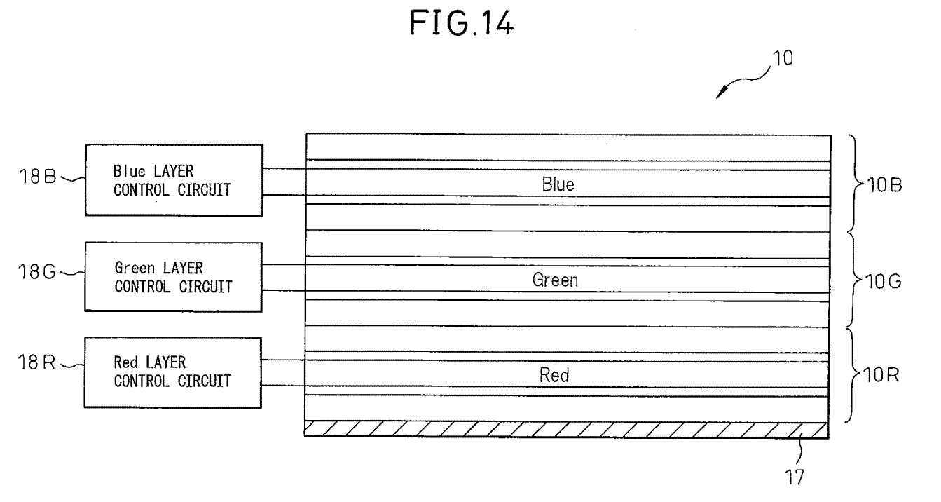

FIG. 14 is a diagram illustrating the configuration of the display device 10 used in the embodiment. As illustrated in FIG. 14, in the display device 10, three panels are stacked into a layer, i.e., a panel 10B for blue, a panel 10G for green and a panel 10R for red in order from the view side, and a light absorbing layer 17 is provided under the panel 10R for red. The panels 10B, 10G and 10R have the same configuration; however, the liquid crystal material and chiral material are selected and the content of the chiral material is determined so that the center wavelength of reflection of the panel 10B is blue (about 480 nm), the center wavelength of reflection of the panel 10G is green (about 550 nm), and the center wavelength of reflection of the panel 10R is red (about 630 nm). The panels 10B, 10G and 10R are driven by a blue layer control circuit 18B, a green layer control circuit 18G and a red layer control circuit 18R, respectively.

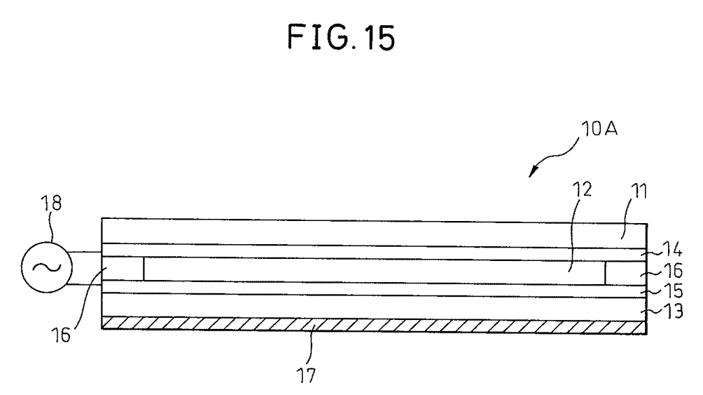

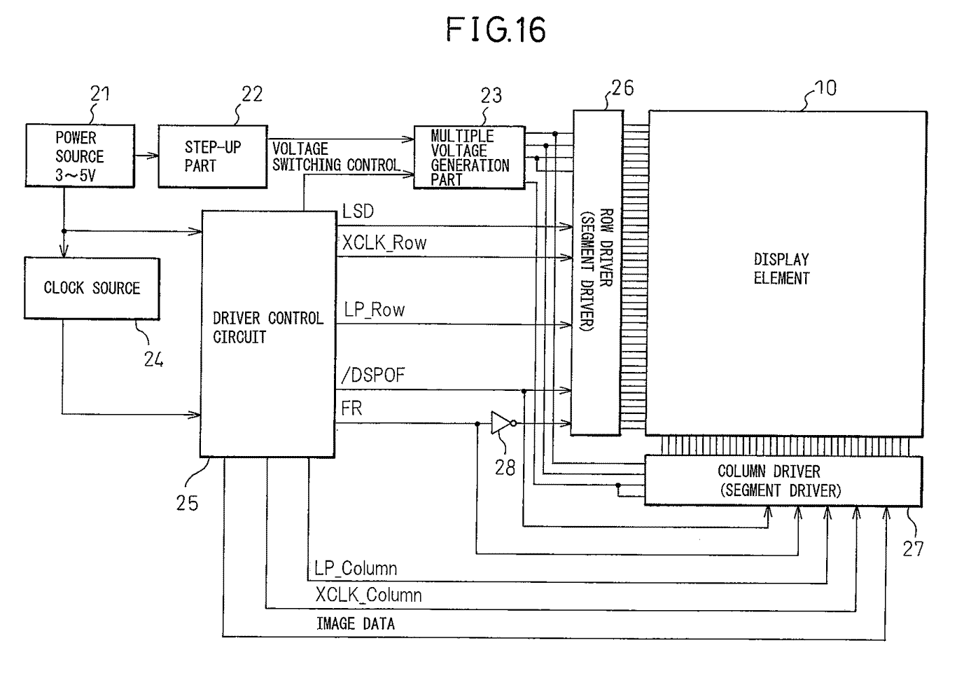

FIG. 15 is a diagram illustrating a basic configuration of the single panel 10A The panel used in the embodiment is explained with reference to FIG. 15.

As illustrated in FIG. 15, the display device 10A has an upper side substrate 11, an upper side electrode layer 14 provided on the surface of the upper side substrate 11, a lower side electrode layer 15 provided on the surface of a lower side substrate 13, and a sealing material 16. The upper side substrate 11 and the lower side substrate 13 are arranged so that their electrodes are in opposition to each other and after a liquid crystal material is sealed in between, they are sealed with the sealing material 16. Within a liquid crystal layer 12, a spacer is arranged; however, it is not illustrated schematically. To the electrodes of the upper side electrode layer 14 and the lower side electrode layer 15, a voltage pulse signal is applied from a drive circuit 18 and due to this, a voltage is applied to the liquid crystal layer 12. A display is produced by applying a voltage to the liquid crystal layer 12 to bring the liquid crystal molecules of the liquid crystal layer 12 into the planar state or the focal conic state.

The upper side substrate 11 and the lower side substrate 13 both have translucency; however, the lower side substrate 13 under the panel 10R does not need to have translucency. Substrates having translucency include a glass substrate, however, in addition to the glass substrate, a film substrate of PET (polyethylene terephthalate) or PC (polycarbonate) may be used.

As the material of the electrode of the upper side electrode layer 14 and the lower side electrode layer 15, a typical one is, for example, indium tin oxide (ITO); however, other transparent conductive films, such as indium zinc oxide (IZO), can be used.

The transparent electrode of the upper side electrode layer 14 is formed on the upper side substrate 11 as a plurality of upper side transparent electrodes in the form of a belt in parallel with each another, and the transparent electrode of the lower side electrode layer 15 is formed on the lower side substrate 13 as a plurality of lower side transparent electrodes in the form of a belt in parallel with each another. Then, the upper side substrate 11 and the lower side substrate 13 are arranged so that the upper side electrode and the lower side electrode intersect each other when viewed in a direction vertical to the substrate and a pixel is formed at the intersection. On the electrode, a thin insulating film is formed. If the thin film is thick, it is necessary to increase the drive voltage. Conversely, if no thin film is provided, a leak current flows, and therefore, there arises a problem that power consumption is increased. The dielectric constant of the thin film is about 5, which is considerably lower than that of the liquid crystal, and therefore, it is appropriate to set the thickness of the thin film to about 0.3 μm or less.

The thin insulating film can be realized by a thin film of SiO2 or an organic film of polyimide resin, acryl resin, etc., known as an orientation stabilizing film.

As described above, the spacer is arranged within the liquid crystal layer 12 and the separation between the upper side substrate 11 and the lower side substrate 13, that is, the thickness of the liquid crystal layer 12 is made constant. Generally, the spacer is a sphere made of resin or inorganic oxide; however, it is also possible to use a fixing spacer obtained by coating a thermoplastic resin on the surface of the substrate. An appropriate range of the cell gap formed by the space is 3.5 μm to 6 μm. If the cell gap is less than this value, reflectivity is reduced, resulting in a dark display, or conversely, if the cell gap is greater than this value, the drive voltage is increased.

The liquid crystal composite that forms the liquid crystal layer 12 is cholesteric liquid crystal, which is nematic liquid crystal mixture to which a chiral material of 10 to 40 weight percent (wt %) is added. The amount of the added chiral material is the value when the total amount of the nematic liquid crystal component and the chiral material is assumed to be 100 wt %.

As the nematic liquid crystal, various liquid crystal materials publicly known conventionally can be used; however, it is desirable to use a liquid crystal material the dielectric constant anisotropy (Δ∈) of which is in the range of 15 to 35. When the dielectric constant anisotropy is 15 or more, the drive voltage becomes comparatively low and if greater than the range, the drive voltage itself is reduced; however, the specific resistance is reduced and power consumption is increased particularly at high temperatures.

It is desirable for the refractive index anisotropy (Δn) to be 0.18 to 0.24. When the refractive index anisotropy is smaller than this range, the reflectivity in the planar state is reduced and when larger than this range, the scattering reflection in the focal conic state is increased and further, the viscosity is also increased and the response speed is reduced.

FIG. 16 is a diagram illustrating a configuration of the entire display device in the present embodiment. The display device 10 is in conformity with the A4 size/XGA specifications and has 1,024×768 pixels. The power source 21 outputs a voltage of, for example, 3 V to 5 V. The step-up part 22 steps up the input voltage from the power source 21 to 36 V to 40 V by a regulator, such as a DC-DC converter. The multiple voltage generation part 23 generates a voltage to be supplied to the row driver 26 and the column driver 27 from the stepped-up voltage. The multiple voltage generation part 23 has a function to switch voltages to be supplied to the row driver 26 based on a voltage switching control signal form the driver control circuit 25. The details of the multiple voltage generation part 23 will be described later.

The driver control circuit 25 generates a control signal based on the base clock from the clock source 24 and image data and supplies the signal to the row driver 26 and the column driver 27. Line selection data LSD is data based on which the row driver 26 selects a line to which a scan pulse is applied. A row data take-in clock XCLK_Row is a clock with which the row driver 26 internally transfers the line selection data LSD. A row data latch signal LP_Row is a signal to specify the completion of the transfer of the line selection data in the row driver 26 and the line selection data transferred in accordance with this signal is latched. A column data take-in clock XCLK_Column is a clock with which the column driver 27 internally transfers image data. A column data latch signal LP_Column is a signal to specify the completion of the transfer of image data in the column driver 27 and the image data transferred in accordance with this signal is latched. The pulse polarity control signal FR is a polarity-inverted signal of an applied voltage and supplied to the column driver 27 as it is; however, supplied to the row driver 26 after it is inverted in an inverter 28. The driver output OFF signal /DSPOF is a forced OFF signal of an applied voltage. Further, the driver control circuit 25 outputs a voltage switching signal to the multiple voltage generation part 23.

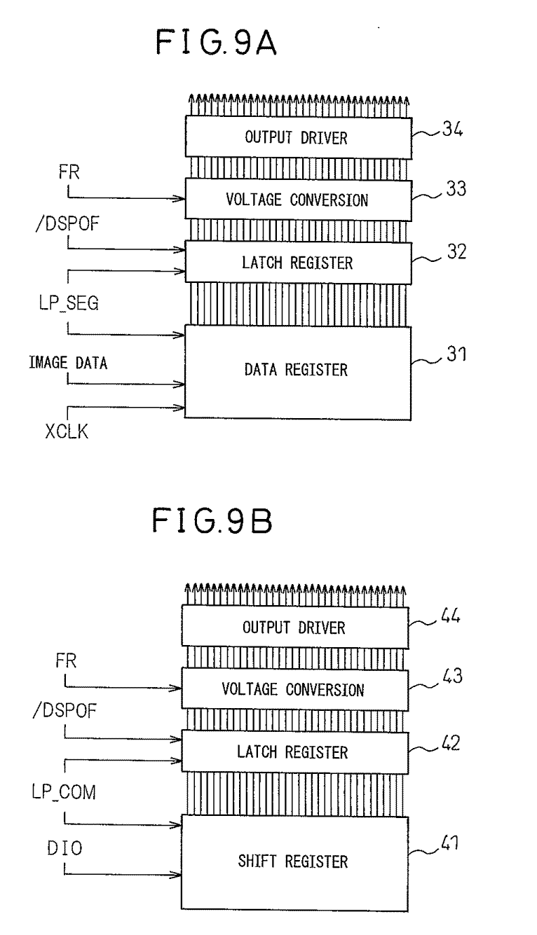

The row driver 26 drives the 768 scan lines and the column driver 27 drives the 1,024 data lines. Because image data given to each pixel of RGB are different, the column driver 27 drives each data line independently. The row driver 26 drives the lines of RGB commonly. The row driver 26 and the column driver 27 are configured by the general-purpose segment driver that outputs two values illustrated in FIG. 9A.

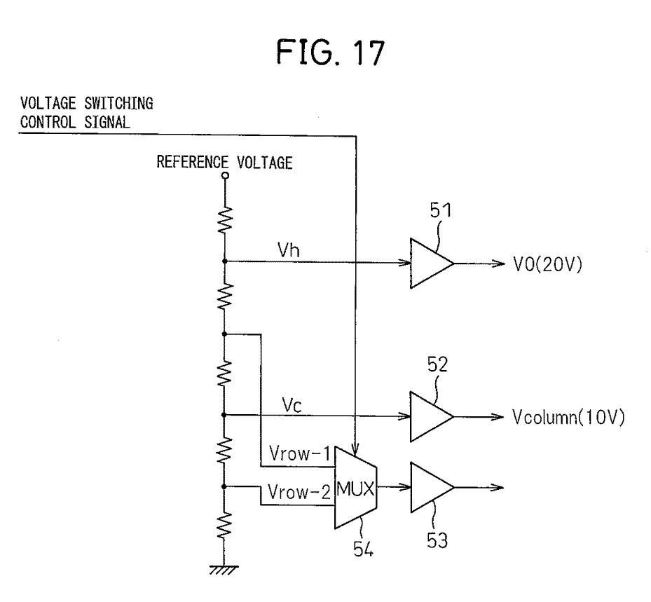

FIG. 17 is a diagram illustrating a configuration of part of the multiple voltage generation part 23. The multiple voltage generation part 23 generates four voltage levels Vh, Vrow−1, Vc and Vrow−2 by dividing the reference voltage using transistors. A multiplexer 54 selects either of the voltage levels Vrow−1 and Vrow−2 in accordance with a voltage switching control signal from the driver control circuit 25 and supplies the voltage level to an amplifier 53 of the operational amplifier. An amplifier 51 amplifies the voltage level Vh and outputs the voltage V0 (20 V). An amplifier 52 amplifies the voltage level Vc and outputs Vcolumn (10 V). The amplifier 53 amplifies either of the voltage levels Vrow−1 and Vrow−2 selected by the multiplexer 54 and outputs the voltage Vrow. The voltage Vrow is 15 V when Vrow−1 is selected and 5 V when Vrow−2 is selected. In addition to the above-described voltages, a voltage of 36 V to be used in reset processing to bring about the planar state is generated; however, it is not illustrated schematically.

Next, the image write operation in the first embodiment is explained.

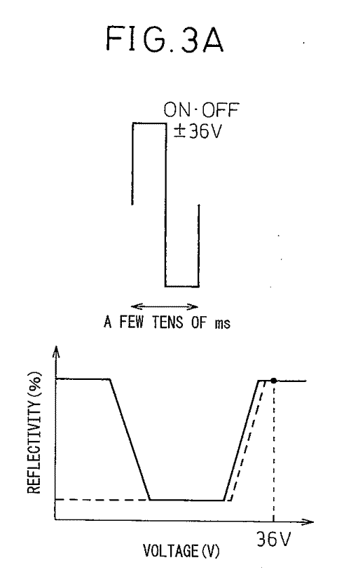

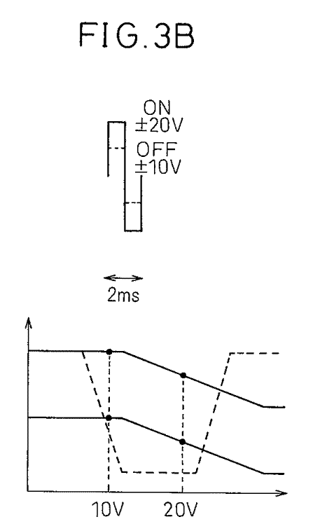

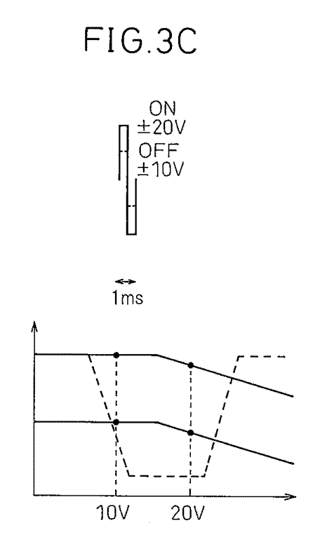

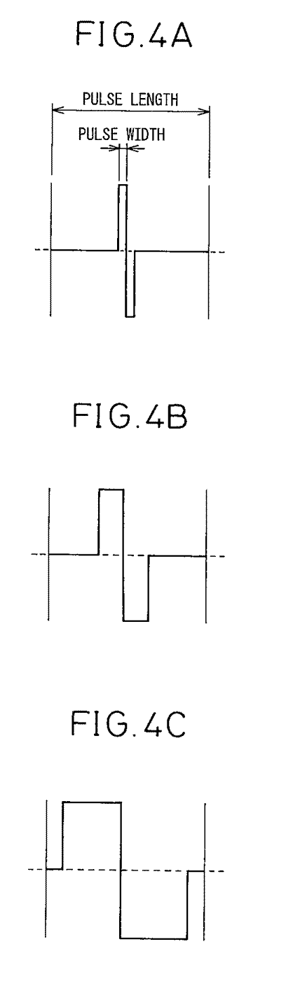

Before the image write operation is performed, the voltage pulse of ±36 V having a pulse width of a few tens of ms or more illustrated in FIG. 3A is applied to all of the pixels to bring all of the pixels into the planar state.

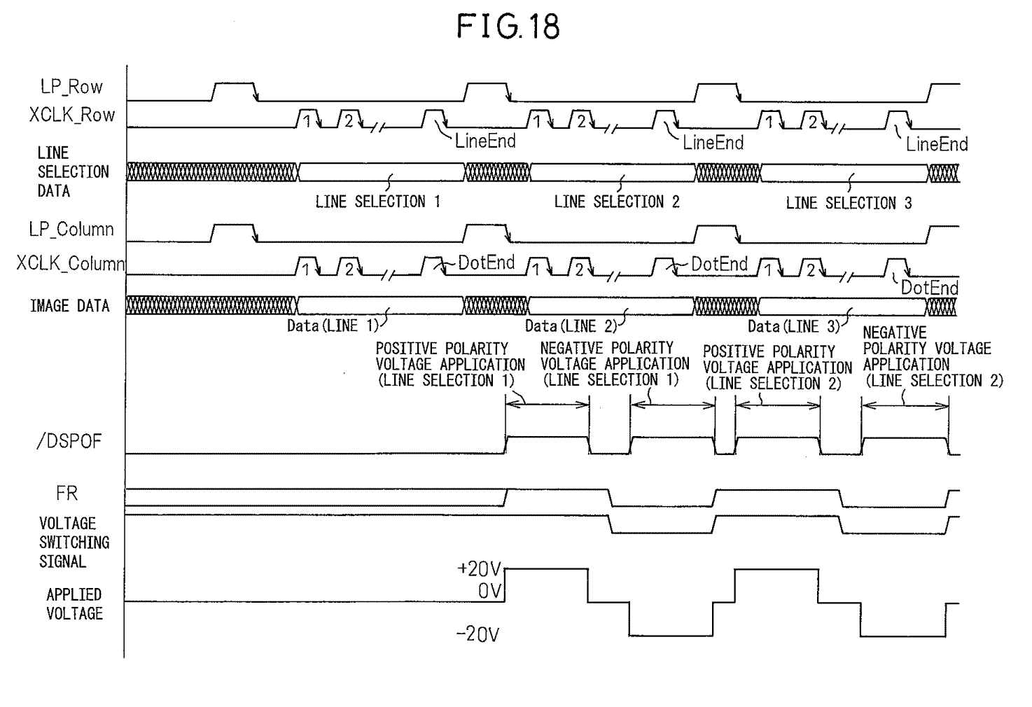

FIG. 18 is a time chart illustrating the drive sequence of the gradation write operation in the display device in the present embodiment. First, settings are made so that the pulse polarity control signal FR is “1”, /DSPOF is “0”, and 15 V is output as the Vrow voltage from the multiple voltage generation part 23.

When LP_Row and LP_Column are applied to update the display line, then the line selection data LSD is supplied to the row driver 26 in accordance with XCLK_Row and data corresponding to one line is supplied to the column driver 27 in accordance with XCLK_Column, and when data indicative of the lines to which a scan line is applied at the same time is prepared in the row driver 26, and pixel data to be applied commonly to the plurality of lines is prepared in the column driver 27, LP_Row and LP_Column are applied. /DSPOF is set to “1” and the column driver 27 outputs a pulse in the positive polarity phase in accordance with image data corresponding to one line to all of the data lines, and the row driver 26 outputs a pulse in the positive polarity phase to one or more selected scan lines. At this time, the pulse in the positive polarity phase output from the row driver 26 is a pulse corresponding to the negative polarity phase of the general-purpose segment driver because the inverted pulse polarity control signal FR is supplied to the row driver 26.

Next, /DSPOF is set to “0” and in the state where no voltage is applied to the display element, the pulse polarity control signal FR is switched from “1” to “0” and the Vrow voltage output from the multiple voltage generation part 23 is changed to 5 V. Then, /DSPOF is set to “1” and the column driver 27 outputs a pulse in the negative polarity phase in accordance with image data corresponding to one line to all of the data lines, and the row driver 26 outputs a pulse in the negative polarity phase to the one or more selected scan lines.

In parallel with the application of the pulses in the positive polarity and negative polarity phases described above, line selection data indicative of the scan line to be selected next and image data are supplied in the same manner as that described above. After that, the same processing is repeated and the pulses in the positive polarity and negative polarity phases in accordance with the display data are applied to the entire screen. When the cumulative application time of the pulse in accordance with the gradation level is adjusted by the number of pulses, the number of times of application a pulse to be applied is changed for each data line and when adjusted by the pulse length, the width of a pulse to be applied is changed for each data line.

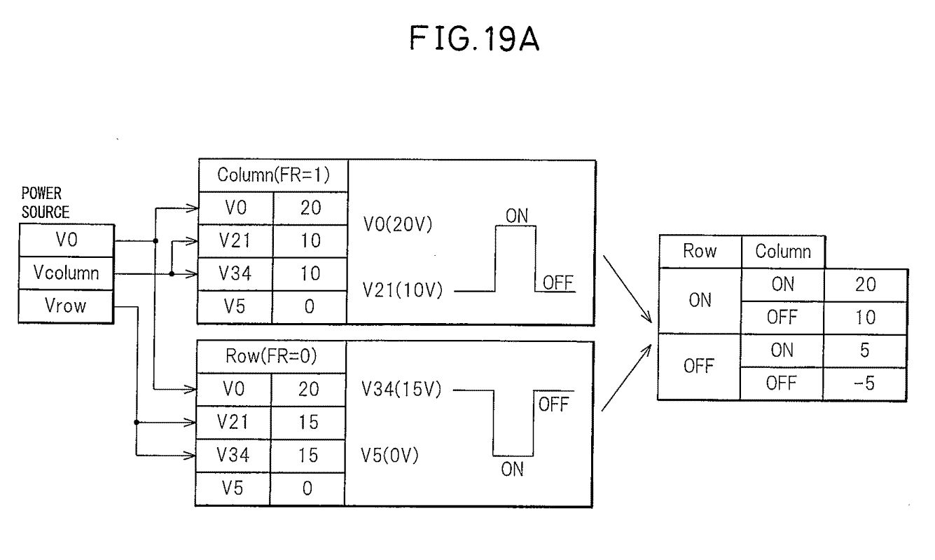

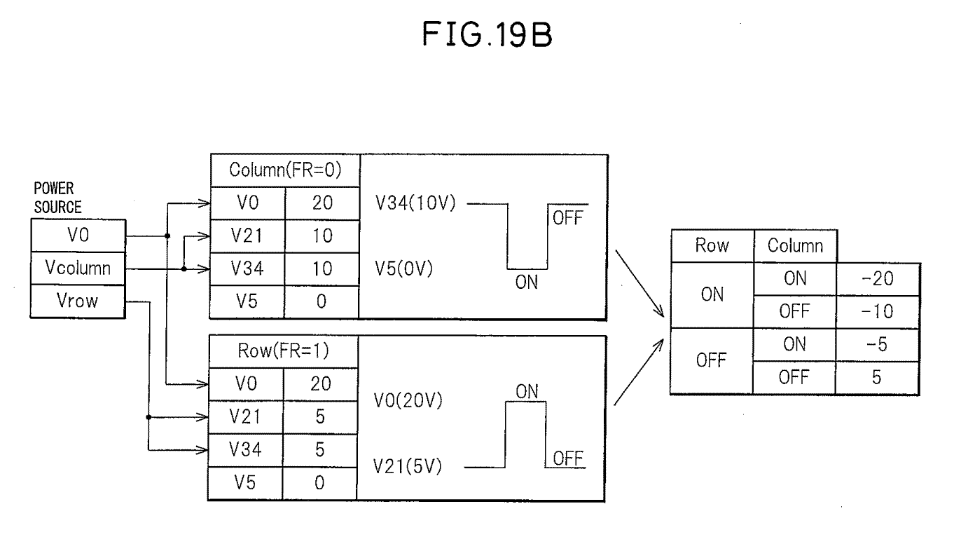

FIG. 19A is a diagram illustrating the output pulses of the column driver 27 and the row driver 26 in the positive polarity phase and the voltages to be applied to liquid crystal thereby. FIG. 19B is a diagram illustrating the output pulses of the column driver 27 and the row driver 26 in the negative polarity phase and the voltages to be applied to liquid crystal thereby.

In the positive polarity phase, at the pulse polarity terminal of the column driver (segment driver) 27, FR=1 and at the pulse polarity terminal of the row driver (segment driver) 26, FR=0. In the multiple voltage generation part 23, the multiplexer 54 selects Vrow−1 by the voltage switching control signal, and therefore, 15 V is output as the Vrow voltage.

Consequently, as illustrated in FIG. 19A, to the column driver 27, 20 V is supplied as V0, Vcolumn (10 V) as V21 and V34, and GND as V5. To the row driver 26, 20 V is supplied as V0, Vrow (15 V) as V21 and V34, and GND as V5. Because of this, the restrictive conditions V0≧V21≧V34≧V5 of the general-purpose segment driver illustrated in FIG. 10A are satisfied.

In the positive polarity phase, as illustrated in FIG. 19A, the column driver 27 outputs the ON voltage V0 (20 V) to the data line where image data is “1”, and the OFF voltage V21 (10 V) to the data line where image data is “0”. Similarly, the row driver 26 outputs the ON voltage V5 (0 V) to the scan line where line selection data is “1”, and the OFF voltage V34 (15 V) to the scan line where line selection data is “0”.

Because of this, 20 V is applied to the pixel where the output of the row driver 26 is ON and the output of the column driver 27 is ON, 10 V to the pixel where the output of the row driver 26 is ON and the output of the column driver 27 is OFF, −5 V to the pixel where the output of the row driver 26 is OFF and the output of the column driver 27 is ON, and −5 V to the pixel where the output of the row driver 26 is OFF and the output of the column driver 27 is OFF.

In the negative polarity phase, at the pulse polarity terminal of the column driver (segment driver) 27, FR=0 and at the pulse polarity terminal of the row driver (segment driver) 26, FR=1. In the multiple voltage generation part 23, the multiplexer 54 selects Vrow−2 by the voltage switching control signal, and therefore, 5 V is output as the Vrow voltage.

Consequently, as illustrated in FIG. 19B, to the column driver 27, 20 V is supplied as V0, Vcolumn (10 V) as V21 and V34, and GND as V5. To the row driver 26, 20 V is supplied as V0, Vrow (5 V) as V21 and V34, and GND as V5. Because of this, the restrictive conditions V0≧V21≧V34≧V5 of the general-purpose segment driver illustrated in FIG. 10A are satisfied.

In the negative polarity phase, as illustrated in FIG. 19B, the column driver 27 outputs the ON voltage V5 (0 V) to the data line where image data is “1”, and the OFF voltage V34 (10 V) to the data line where image data is “0”. Similarly, the row driver 26 outputs the ON voltage V0 (20 V) to the scan line where line selection data is “1”, and the OFF voltage V21 (5 V) to the scan line where line selection data is “0”.

Because of this, −20 V is applied to the pixel where the output of the row driver 26 is ON and the output of the column driver 27 is ON, −10 V to the pixel where the output of the row driver 26 is ON and the output of the column driver 27 is OFF, −5 V to the pixel where the output of the row driver 26 is OFF and the output of the column driver 27 is ON, and 5 V to the pixel where the output of the row driver 26 is OFF and the output of the column driver 27 is OFF.

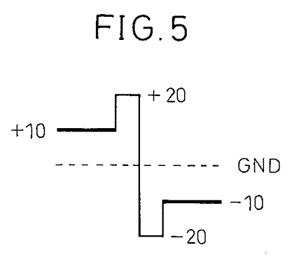

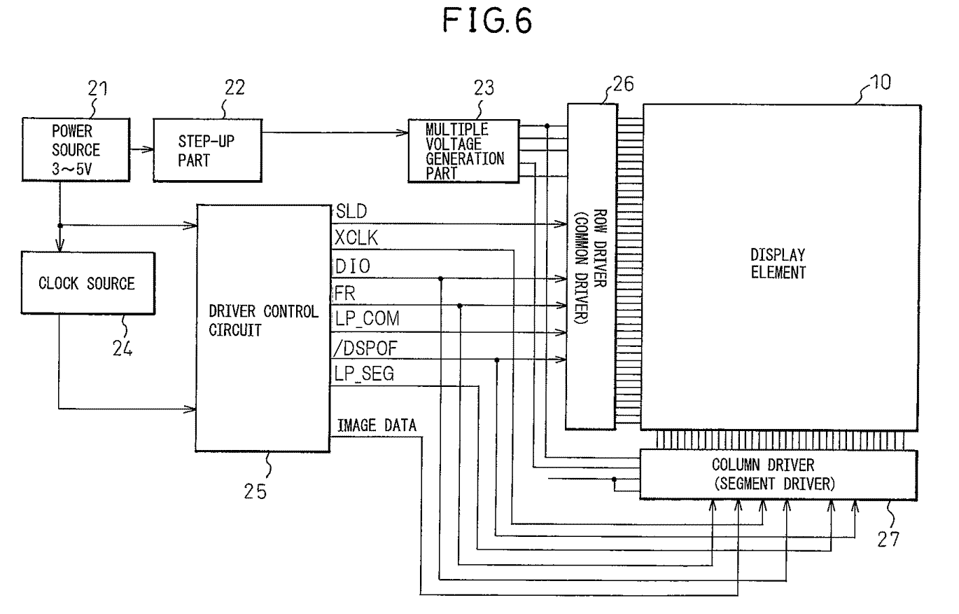

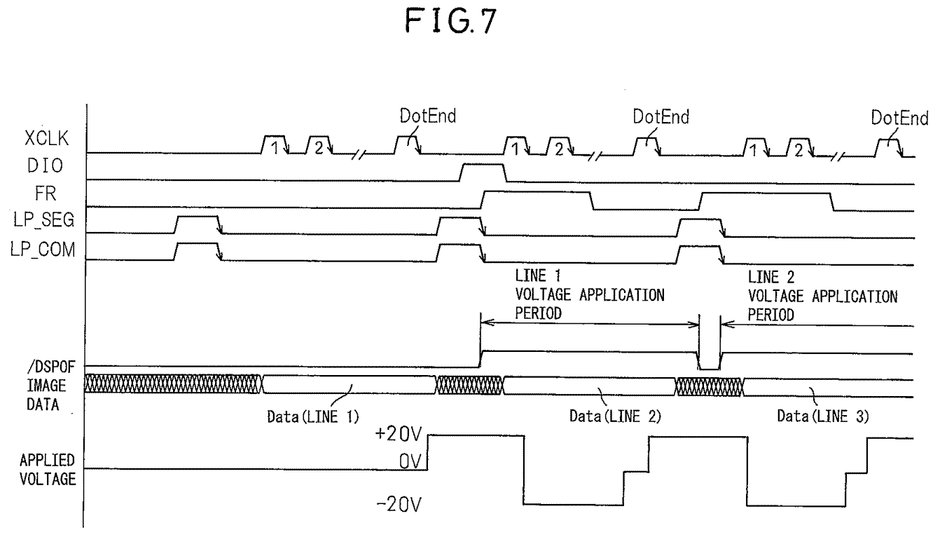

In the manner described above, the positive and negative symmetric gradation pulses as illustrated in FIG. 5 are applied to each pixel.

As described above, in the present embodiment, the restrictive conditions V0≧V21≧V34≧V5 of the general-purpose are satisfied and then it is possible to use the general-purpose segment driver as a scan driver (row driver). Further, in the present embodiment, the drive voltages are the same as those in the conventional example. Furthermore, conventionally, the four voltages 20 V, 15 V, 10 V and 5 V are amplified by the amplifier of the operational amplifier, respectively; however, in the present embodiment, 15 V and 5 V of 20 V, 15 V, 10 V and 5 V are supplied to the amplifier by switching with the multiplexer, and therefore, the number of amplifiers of the operational amplifier is three and the cost can be reduced. It is also possible to use a voltage follower having an amplification factor of 1 instead of the amplifier of the operational amplifier.

Unlike the common driver, the segment driver is capable of not only shifting data but also outputting in a variety of ways, and therefore, it is possible to simultaneously drive a plurality of lines as illustrated in FIG. 13A and FIG. 13B by using an inexpensive general-purpose segment driver. Further, it is also possible for a general-purpose segment driver to receive the next line data while outputting a voltage to the drive line and to drive at a data transfer efficiency equivalent to that of a dedicated driver.

The embodiment is explained as above, however, it is obvious that there can also be various modifications. For example, the embodiment can be applied to a display element of dot matrix type having memory properties, in addition to the display element that uses cholesteric liquid crystal.

It is obvious that the various conditions should be determined in accordance with the specifications of a target display element.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiment of the present invention have been described in detail, it should be understood that the various changes, substitutions, and alterations could be made hereto without departing from the spirit and scope of the invention.

What is claimed is:

1. A display device comprising:
a display element of dot matrix type;
a row driver that drives a row electrode of the display element;
a column driver that drives a column electrode of the display element; and
a multiple voltage power source that supplies a drive voltage to the row driver and the column driver, wherein:
the row driver and the column driver are configured by a segment driver; and
the device comprises a power source switching switch which switches drive voltages to be supplied to the row driver in accordance with the polarity of an applied voltage to be applied to a pixel of the display element.

2. The display device according to claim 1, wherein:
a polarity control signal to be supplied to the segment driver constituting the row driver is an inverted signal of a polarity control signal to be supplied to the general-purpose segment driver constituting the column driver.

3. The display device according to claim 1, wherein:
the display element comprises liquid crystal that forms a cholesteric phase.

4. The display device according to claim 3, wherein:
an initial gradation state is a planar state and a gradation state other than the initial gradation state is a state where the planar state and a focal conic state coexist in a mixed condition and a halftone value is determined by a coexistence ratio.

5. The display device according to claim 4, wherein:
the display element is brought into the initial gradation state by the application of an initialization voltage pulse to a pixel and then is brought into a gradation state other than the initial gradation state by the application of a gradation voltage pulse to the initialized pixel; and
the cumulative time during which the gradation pulse is applied is related to a value of a gradation state.

6. The display device according to claim 1, wherein:
the display element comprises a laminated structure in which a plurality of display elements that exhibit a plurality of different kinds of reflected light are laminated.

7. A method of driving a display device, the display device comprising:
a display element of dot matrix type;
a row driver that drives a row electrode of the display element;
a column driver that drives a column electrode of the display element; and
a multiple voltage power source that supplies a drive voltage to the row driver and the column driver, wherein:
the row driver and the column driver are configured by a segment driver; and
drive voltages to be supplied to the row driver are switched in accordance with the polarity of an applied voltage to be applied to a pixel of the display element.

8. The method of driving a display device according to claim 7, wherein
a polarity control signal to be supplied to the segment driver constituting the row driver is an inverted signal of the polarity control signal to be supplied to the segment driver constituting the column driver.

9. The method of driving a display device according to claim 7, wherein
the display element includes liquid crystal that forms a cholesteric phase.

10. The method of driving a display device according to claim 9, wherein
an initial gradation state is a planar state and a gradation state other than the initial gradation state is a state where the planar state and a focal conic state coexist a mixed condition and a halftone value is determined by a coexistence ratio.

11. The method of driving a display device according to claim 10, wherein:
the display element is brought into the initial gradation state by the application of an initialization voltage pulse to a pixel and then is brought into a gradation state other than the initial gradation state by the application of a gradation voltage pulse to the initialized pixel; and
the cumulative time during which the gradation pulse is applied is related to a value of a gradation state.

12. The method of driving a display device according to claim 7, wherein
the display element comprises a laminated structure in which a plurality of display elements that exhibit a plurality of different kinds of reflected light are laminated.
